(19) United States
(12) Patent Application Publication
(10) Pub. No.: US 2026/0187884 A1
(43) Pub. Date: Jul. 2, 2026

(54) SYSTEMS AND METHODS FOR SELF-CALIBRATION IN PROJECTION-BASED 2D-TO-3D RECONSTRUCTION

(71) Applicant: XPlan AI, Jerusalem (IL)

(72) Inventor: Adam Kaufman, Jerusalem (IL)

(73) Assignee: XPlan AI, Jerusalem (IL)

(21) Appl. No.: 19/420,160

(22) Filed: Dec. 15, 2025

Related U.S. Application Data
(60) Provisional application No. 63/739,581, filed on Dec. 29, 2024.

(51) Int. Cl. G06T 12/10; G06T 7/00; G06T 7/11; G06T 7/174; G06T 7/20; G06T 7/33; G06T 7/80; G06T 12/20

(52) U.S. Cl. CPC G06T 12/10; G06T 7/0014; G06T 7/11; G06T 7/174; G06T 7/20; G06T 7/337; G06T 7/80; G06T 12/20; G06T 2207/10081; G06T 2207/20081; G06T 2207/20084; G06T 2207/30012; G06T 2210/41; G06T 2211/441

(57) ABSTRACT

A training methodology and an inference-time calibration procedure for producing and using a reconstruction-aware learned similarity metric for camera pose refinement is disclosed. During an inference process, a trained reprojection consistency score network guides optimization of camera parameters by repeatedly reconstructing and projecting a 3D volume, computing the reprojection consistency score against input images, and updating camera parameters to improve geometric consistency. The inference loop corrects pose miscalibrations even when initial deviations are large or when the underlying reconstructor produces only a domain-specific, limited representation of the anatomy.

### CROSS-REFERENCE TO RELATED APPLICATIONS

This application claims priority under 35 U.S.C. § 119(e) to commonly owned U.S. Provisional Application No. 63/739,581, filed Dec. 29, 2024, entitled “Methods And Systems For Precise And Robust 3D Reconstruction Of Anatomical Structures,” the entirety of which is incorporated herein by reference for all purposes.

### FIELD OF THE DISCLOSURE

The disclosure relates to medical image computing, and pose self-calibration, and, in particular, to training and deployment of a reconstruction-aware learned similarity metric used to refine relative imaging geometry in multi-view 2D-to-3D reconstruction pipelines.

### BACKGROUND

Reconstructing three-dimensional anatomical structures from a small number of X-ray projections is a difficult task that cannot always be reliably solved by classical analytic tomographic methods. Neural network-based 2D-to-3D reconstruction methods enable high-quality inference of volumetric anatomy from sparse multi-view X-ray inputs.

Accurate reconstruction requires correct intrinsic and extrinsic camera parameters for each input view. In practical settings, these parameters may be inaccurate or unknown. Tracked C-arm systems may exhibit residual pose errors of approximately 1-2 degrees. In office-based or untracked imaging environments, commonly acquired ‘AP-Lateral’ views may deviate from orthogonality by as much as 20 degrees. Such errors cause the reconstructed 3D volume to deviate from true anatomy, introducing distortions and inconsistencies.

Traditional 2D-3D registration aligns a fixed 3D volume to X-ray images by optimizing similarity metrics such as NCC, MI, or gradient NCC (gNCC) between measured radiographs and Digitally Reconstructed Radiographs (DRRs). Such methods assume the 3D volume is fixed and fully represents all anatomy present in the X-ray images.

However, neural reconstruction pipelines violate this assumption because the reconstructed volume depends on the hypothesized camera geometry. Furthermore, reconstruction networks may produce limited Field-Of-View (FOV) or domain-specific representations such as bone segmentation masks, whose DRRs naturally omit soft-tissue or out-of-FOV content visible in the input X-rays. Classical similarity metrics fail under such mismatches. Therefore, for effective self-calibration of neural reconstruction pipelines, a reconstruction-aware similarity metric is needed.

Accordingly, a reconstruction-aware similarity metric is needed for effective self-calibration of neural reconstruction pipelines.

A further need exists for a training methodology and an inference-time calibration procedure for producing and using a reconstruction-aware learned similarity metric for camera pose refinement.

### SUMMARY

Disclosed are methods and systems for self-calibrating camera parameters in projection-based two-dimensional-to-three-dimensional reconstruction. Specifically, a training methodology and an inference-time calibration procedure for producing and using a reconstruction-aware learned similarity metric for camera pose refinement is disclosed. During an inference process, a trained reprojection consistency score network guides optimization of camera parameters by repeatedly reconstructing and projecting a 3D volume, computing the reprojection consistency score against input images, and updating camera parameters to improve geometric consistency. The inference loop corrects pose miscalibrations even when initial deviations are large or when the underlying reconstructor produces only a domain-specific, limited representation of the anatomy.

In the disclosed training methodology, training data comprises, for each example, at least one projection input image, ground-truth camera parameters, and a ground-truth three-dimensional representation. A representation function maps the three-dimensional representation into a domain used by a reconstruction module, and projections of the ground-truth and reconstructed representations are compared using a similarity function to produce a target similarity value. A neural reprojection consistency score network, also referred to as a reconstruction-aware learned similarity metric, is trained to predict the target similarity value from the projection input image and a corresponding reprojection image. In embodiments, the neural reprojection consistency score network is trained using a supervision target derived from comparing projections of: (i) a ground-truth 3D representation transformed into the representation domain of the reconstruction module, and (ii) a reconstructed 3D representation generated under perturbed camera parameters. The reprojection consistency score network thus becomes sensitive only to representable anatomical content, and robust to domain mismatch, missing soft tissue, and variations in field-of-view.

At inference, the trained network evaluates reprojection consistency for at least one projection input image and a corresponding reprojection of a reconstruction, and an optimizer iteratively updates camera parameters to maximize consistency, thereby refining imaging geometry and improving three-dimensional reconstructions.

In some embodiments, the representation domain is a 3D segmentation or occupancy mask, and the training target is a comparison of projected masks (e.g., via gradient-domain similarity, Dice, Tversky, IoU, or distance-transform correlation). In broader embodiments, the representation domain may include attenuation, gradient fields, or latent learned features, and similarity may include NCC, gNCC, MI, SSIM, Chamfer distance between silhouettes, or combinations thereof.

According to one aspect of the disclosure, a computer-implemented method of training a reconstruction-aware learned similarity metric for self-calibrating relative camera parameters used in multi-view projection-based two-dimensional-to-three-dimensional reconstruction, comprises the acts of: (a) obtaining a ground-truth three-dimensional representation of an object and ground-truth camera parameters for at least one two-dimensional projection input image of the object; (b) defining a representation function that maps a three-dimensional representation into a representation domain used by a two-dimensional-to-three-dimensional reconstruction module; (c) projecting the ground-truth three-dimensional representation under the ground-truth camera parameters to obtain a first two-dimensional reprojection image; (d) reconstructing, using a reconstruction module and the at least one two-dimensional projection input image, a perturbed three-dimensional reconstruction based on estimated camera parameters that differ from the ground-truth camera parameters, and projecting the perturbed three-dimensional reconstructed representation under the estimated camera parameters to obtain a second two-dimensional reprojection image; (e) determining, by applying a similarity function configured to quantify agreement between the first and second two-dimensional reprojection images, a target similarity value; and (f) training the reconstruction-aware learned similarity metric using training input data comprising the at least one two-dimensional projection input image and a corresponding second two-dimensional reprojection image, so that the reconstruction-aware learned similarity metric is configured to output a similarity score that approximates the target similarity value. In embodiments, the representation function expresses the three-dimensional representation as a three-dimensional segmentation or occupancy representation of at least one anatomical structure. In embodiments, act (c) comprises any of: c1) generating a DRR of a three-dimensional segmentation or occupancy representation of at least one anatomical structure, or c2) generating a DRR of three-dimensional gradients of a three-dimensional segmentation or occupancy representation of at least one anatomical structure. In embodiments, the ground-truth three-dimensional representation comprises at least one of: (i) a three-dimensional segmentation mask derived from a ground-truth volumetric image; and (ii) a three-dimensional reconstruction generated using the reconstruction module under the ground-truth camera parameters. In embodiments, the representation function expresses the three-dimensional representation as any of: an attenuation or density representation, a gradient-domain representation, a distance-based representation, an implicit field, a radiance representation, a latent feature representation used by the reconstruction module, or combinations thereof. In embodiments, act (e) comprises: (e1) evaluating a similarity function selected from a class of functions configured to measure agreement between corresponding pixels or regions of the first and second two-dimensional representation images. In embodiments, the selected similarity function is configured to measure agreement on any of intensity-based, gradient-based, mask-based, silhouette-based, distance-transform-based, or feature-space-based similarity functions, or combinations thereof. In embodiments, prior to act (c), restricting the ground-truth three-dimensional representation according to at least one reconstruction-conditioned criterion so that the first two-dimensional reprojection image corresponds substantially to a region that is representable by the reconstruction module given the at least one projection input images. In embodiments, the restricting comprises determining a reconstruction-conditioned sub-volume based on at least one of: (i) a bounding region derived from a three-dimensional reconstruction generated under the ground-truth camera parameters; (ii) a ray-coverage or overlap criterion; or (iii) an overlap map predicted by a neural network. In embodiments, act e) comprises aggregating similarity values across multiple views.

According to another aspect of the disclosure, computer program product comprising a non-transitory computer-readable medium storing instruction that, when executed by a processor, cause the processor to perform a method of training a reconstruction-aware learned similarity metric for self-calibrating relative camera parameters used in multi-view projection-based two-dimensional-to-three-dimensional reconstruction, the method comprising: (a) obtaining a ground-truth three-dimensional representation of an object and ground-truth camera parameters for at least one two-dimensional projection input image of the object; (b) defining a representation function that maps a three-dimensional representation into a representation domain used by a two-dimensional-to-three-dimensional reconstruction module; (c) projecting the ground-truth three-dimensional representation under the ground-truth camera parameters to obtain a first two-dimensional reprojection image; (d) reconstructing, using the reconstruction module and the at least one two-dimensional projection input image, a perturbed three-dimensional reconstruction based on estimated camera parameters that differ from the ground-truth camera parameters, and projecting the reconstructed representation under the estimated camera parameters to obtain a second two-dimensional reprojection image; (e) determining, by applying a similarity function configured to quantify agreement between the first and second two-dimensional reprojection images, a target similarity value; and (f) training the reconstruction-aware learned similarity metric using training input data comprising at least one two-dimensional projection input image and corresponding second two-dimensional reprojection image, so that the reconstruction-aware learned similarity metric is configured to output a similarity score that approximates the target similarity value.

According to yet another aspect of the disclosure, a system comprising one or more processors and memory storing instructions which, when executed by the one or more processors, cause the system to perform a method of training a reconstruction-aware learned similarity metric for self-calibrating relative camera parameters used in multi-view projection-based two-dimensional-to-three-dimensional reconstruction, the method comprising: (a) obtaining a ground-truth three-dimensional representation of an object and ground-truth camera parameters for at least one two-dimensional projection input image of the object; (b) defining a representation function that maps a three-dimensional representation into a representation domain used by a two-dimensional-to-three-dimensional reconstruction module; (c) projecting the ground-truth three-dimensional representation under the ground-truth camera parameters to obtain a first two-dimensional reprojection image; (d) reconstructing, using the reconstruction module and the at least one two-dimensional projection input image, a perturbed three-dimensional reconstruction based on estimated camera parameters that differ from the ground-truth camera parameters, and projecting the reconstructed representation under the estimated camera parameters to obtain a second two-dimensional reprojection image; (e) determining, by applying a similarity function configured to quantify agreement between the first and second two-dimensional reprojection images, a target similarity value; and (f) training the reconstruction-aware learned similarity metric using training input data comprising at least one two-dimensional projection input image and corresponding second two-dimensional reprojection image, so that the reconstruction-aware learned similarity metric is configured to output a similarity score that approximates the target similarity value.

According to still another aspect of the disclosure, a computer-implemented method for self-calibrating relative camera parameters of imaging devices configured to acquire two-dimensional projection images of a three-dimensional object, the method comprising the following acts: (a) receiving at least one projection input image of the object; (b) receiving or estimating initial approximate camera parameters associated with the at least one projection input image; (c) generating, using a two-dimensional-to-three-dimensional reconstruction module, a three-dimensional reconstruction of the object based on the at least one projection input image and the initial approximate camera parameters, the three-dimensional reconstruction belonging to a representation domain used by the reconstruction module; (d) projecting the three-dimensional reconstruction using the approximate camera parameters to obtain, for each view, a two-dimensional reprojection image; (e) for each view, computing a reprojection consistency score using a reconstruction-aware learned similarity metric, the reconstruction-aware learned similarity metric receiving the corresponding projection input image and the corresponding two-dimensional reprojection image; (f) updating at least one camera parameter based at least in part on the reprojection consistency score; and (g) repeating steps (c)-(f) until a convergence condition is satisfied, thereby producing refined camera parameters and an improved three-dimensional reconstruction. In embodiments, the at least one projection input image comprises at least a pair of projection input images acquired nominally in a predetermined configuration and act (b) comprises using such predetermined configuration. In embodiments, the imaging device comprises a tracked C-arm system, and act (b) comprises receiving initial approximate camera parameters from such tracked C-arm system. In embodiments, the at least one projection input image includes at least a pair of projection input images, and act (b) comprises detecting corresponding landmarks in the at least a pair of projection input images and calculating the initial approximate camera parameters using a geometry-based relative pose estimation algorithm. In embodiments, the representation domain comprises a three-dimensional segmentation or occupancy representation, and the reprojection consistency score reflects agreement between projected segmentation or occupancy representation and anatomical structures visible in the projection input images. In embodiments, act (f) comprises determining gradients of the reprojection consistency score with respect to at least one of the camera parameters by backpropagating through at least a projection operation, and applying a gradient-based optimization algorithm. In embodiments, act (f) comprises using a global optimizer such as a Covariance Matrix Adaptation Evolution Strategy (CMAES). In embodiments, act (f) comprises refining at least one rotational degree of freedom and/or at least one translational degree of freedom around the initial approximate camera parameters, and further including imposing a prior favoring refined camera parameters that are similar to initial approximate camera parameters and/or consistent with a predetermined nominal constraint such as orthogonality. In embodiments, the reprojection consistency score is aggregated across a plurality of views.

According to yet another aspect of the disclosure, a computer program product comprising a non-transitory computer-readable medium storing instruction that, when executed by a processor, cause the processor to perform a method for self-calibrating relative camera parameters of imaging devices configured to acquire two-dimensional projection images of a three-dimensional object, the method comprising: (a) receiving at least one projection input image of the object; (b) receiving or estimating initial approximate camera parameters associated with the at least one projection input image; (c) generating, using a two-dimensional-to-three-dimensional reconstruction module, a three-dimensional reconstruction of the object based on the at least one projection input image and the approximate camera parameters, the reconstruction belonging to a representation domain used by the reconstruction module; (d) projecting the three-dimensional reconstruction using the approximate camera parameters to obtain, for each view, a two-dimensional reprojection image; (e) for each view, computing a reprojection consistency score using a reconstruction-aware learned similarity metric, the reconstruction-aware learned similarity metric receiving the corresponding projection input image and the corresponding two-dimensional reprojection image; (f) updating at least one camera parameter based at least in part on the reprojection consistency score; and (g) repeating steps (c)-(f) until a convergence condition is satisfied, thereby producing refined camera parameters and an improved three-dimensional reconstruction.

According to still yet another aspect of the disclosure, a system comprising one or more processors and memory storing instructions which, when executed by the one or more processors, cause the system to perform a method for self-calibrating relative camera parameters of imaging devices configured to acquire two-dimensional projection images of a three-dimensional object, the method comprising: (a) receiving at least one projection input image of the object; (b) receiving or estimating initial approximate camera parameters associated with the at least one projection input image; (c) generating, using a two-dimensional-to-three-dimensional reconstruction module, a three-dimensional reconstruction of the object based on the at least one projection input image and the approximate camera parameters, the reconstruction belonging to a representation domain used by the reconstruction module; (d) projecting the three-dimensional reconstruction using the approximate camera parameters to obtain, for each view, a two-dimensional reprojection image; (e) for each view, computing a reprojection consistency score using a reconstruction-aware learned similarity metric, the reconstruction-aware learned similarity metric receiving the corresponding projection input image and the corresponding two-dimensional reprojection image; (f) updating at least one camera parameter based at least in part on the reprojection consistency score; and (g) repeating steps (c)-(f) until a convergence condition is satisfied, thereby producing refined camera parameters and an improved three-dimensional reconstruction.

### BRIEF DESCRIPTION OF THE DRAWINGS

This patent or application file contains at least one drawing executed in color. Copies of this patent or patent application publication with color drawing(s) will be provided by the Office upon request and payment of the necessary fee.

The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. Furthermore, elements may not be drawn to scale.

FIG. 1A is a conceptual illustration of a tracked C-arm system suitable for use with the disclosed surgical navigation system and method, in accordance with the disclosure.

FIGS. 1B and 1C conceptual illustration of an untracked X-ray imaging system suitable for use with the disclosed method.

FIGS. 2A and 2B illustrate two exemplary methods for implementing a reconstruction-aware learned similarity metric training pipeline in accordance with the disclosure.

FIG. 3A illustrates a 2D projection input image in the form of an X-ray image in accordance with the disclosure.

FIG. 3B illustrates an optional 2D segmentation mask of the 2D projection input image of FIG. 3A in accordance with the disclosure.

FIG. 3C illustrates reprojection image in the form of a reconstruction DRR in accordance with the disclosure.

FIG. 3D illustrates a reprojection image in the form of a reconstruction 3D gradient DRR in accordance with the disclosure.

FIG. 3E illustrates conceptually an exemplary learned similarity metric (view consistency score) in the form of a regressor network in accordance with the disclosure.

FIGS. 4A and 4B are X-ray images of the patient anatomy of FIG. 4C in accordance with the disclosure.

FIG. 4C is a full-FOV of a patient anatomy in accordance with the disclosure.

FIGS. 4D and 4E are DRR's embodying representation 2D reprojection images generated by reprojection of a limited-FOV reconstructed 3D volume, in accordance with the disclosure.

FIG. 4F is a limited-FOV reconstructed 3D volume representing only partial anatomy in accordance with the disclosure.

FIG. 5 is a flowchart of an inference-time iterative self-calibration procedure in accordance with the disclosure.

FIG. 6A illustrates the initial reconstruction LAT DRR generated using initial estimated LAT camera, with initial reconstruction 3D gradient LAT DRR shown overlaid in blue in accordance with the disclosure.

FIG. 6B illustrates an shows the LAT X-ray image with initial reconstruction 3D gradient LAT DRR shown overlaid in blue in accordance with the disclosure.

FIG. 6C illustrates an area in which the initial reconstruction 3D gradient LAT DRR is mismatched with the underlying LAT X-ray image at the contour of one of the condyles in accordance with the disclosure.

FIG. 6D illustrates a final reconstruction LAT DRR generated using final estimated LAT camera parameters optimized using the self-calibration procedure, with the final reconstruction 3D gradient LAT DRR shown overlaid in blue, in accordance with the disclosure.

FIG. 6E illustrates the LAT X-ray image with final, optimized reconstruction 3D gradient LAT DRR shown overlaid in blue, in accordance with the disclosure.

FIG. 6F illustrates an area in which the final reconstruction 3D gradient LAT DRR is correctly matched with the underlying LAT X-ray image at the contour of one of the condyles, in accordance with the disclosure.

FIG. 7 is a conceptual illustration of a computer system suitable for use with the disclosed system and methods.

### DETAILED DESCRIPTION

Unless stated otherwise, the terms “reconstruction-aware learned similarity metric”, “reprojection consistency score”, and “reprojection consistency score network” are used interchangeably to refer to this learned similarity module.

The disclosed systems and methods utilize radiographic data, as well as optional optical data, to enhance imaging capabilities. In some embodiments, such systems and methods may use the enhanced radiographic imaging information to facilitate surgical planning. In other embodiments, such systems and methods may combine both visually obtained patient pose position information and radiographic image information to facilitate calibrated surgical navigation. Such process involves a data acquisition phase, a system calibration phase, a volume reconstruction phase, as well as an optional surgical navigation phase optionally resulting in the alignment of instrument coordinates with the patient and reconstructed volume coordinates enabling tracking and navigation of surgical instruments within a reconstructed 3D volume of a patient anatomy, even if the such anatomy is not exposed during a procedure. The data acquisition phase, volume reconstruction phase, and optional surgical navigation phase are described in detail in U.S. Pat. Nos. 12,361,631, 12,444,127, 12,462,469, US Patent Application Publication US20240185509A1 and US Patent Application Publication US20250186163-A1, the subject matters of which are incorporated herein by this reference for all purposes.

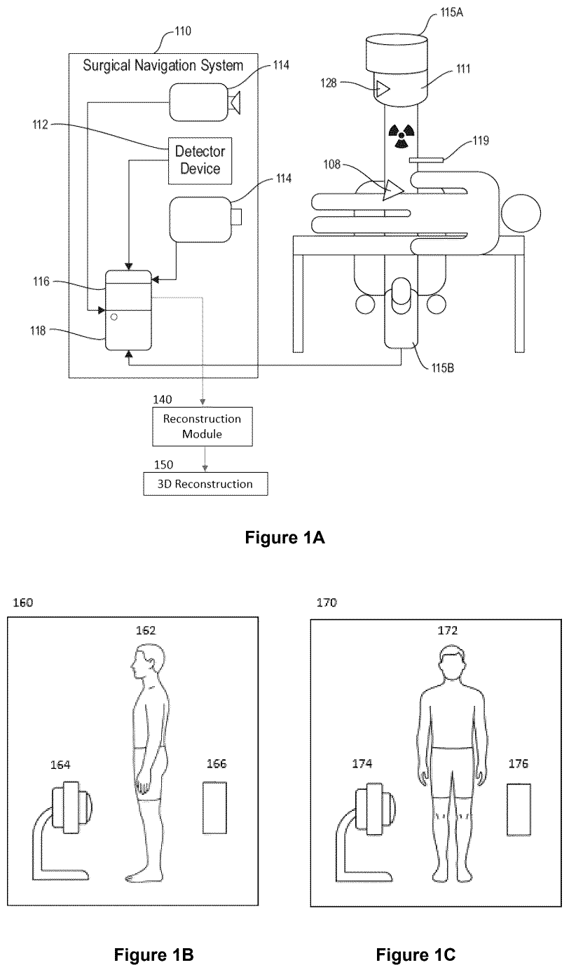

FIG. 1A is a conceptual illustration of a tracked C-arm system suitable for use with disclosed embodiments. The system 110 is used with an X-ray imaging device for acquiring at least one projection input image of a patient anatomy. In embodiments, multiple projection images may be acquired at predetermined approximate orientations, by repositioning the imaging device at appropriate orientations before each image acquisition. The surgical navigation system 110 may be used with a traditional fluoroscopy machine, e.g. a C-arm, having a source of radiation 115B disposed beneath the patient and a radiographic image detector 115A disposed on the opposite side of the patient.

In embodiments, surgical navigation system 110 comprises reference markers 108 or 128, a radiation detector/synchronizing device 112, a calibration target 111, cameras 114, computer 118, and a display interface 116 used with a radiation source 115B and radiographic image detector 115A, device 115A. In embodiments, the components of surgical navigation system 110 may be contained within a single housing which is easily positionable along three axes within the surgical procedure space. Alternatively, one or more the components of surgical navigation system 110 may be located remotely from other components but interoperable therewith through suitable network infrastructure. The surgical system 110, and particularly cameras 114, track the reference marker 108 or 128 within the camera coordinate system, e.g. the patient coordinate system, and forward the positional information of the reference markers onto computer 118 for further processing.

One or more external optical camera 114 may be positioned to capture the operating area, as illustrated, and detect optical reference marker 108 attached to the patient and the reference marker 128 attached to the calibration target 111. External optical camera 14 provides real-time tracking of the 6-DoF poses (rotation and translation) of the markers 108 and 128. In embodiments, camera 114 may be implemented using one or more visible light cameras to capture real-time images of the surgical field including the patient and X-ray imaging system, e.g. a fluoroscope. A camera suitable for use as camera 114 is the Polaris product line of optical navigation products, commercially available from Northern Digital, Waterloo, Ontario, Canada. Visible light cameras or infrared cameras may be used as camera 114. External camera 114 may be in communication with one or both of synchronizing device 112 and a processing unit 118. When the imaging systems X-ray is triggered, synchronizing device 112 identifies X-ray emissions relative to a predefined threshold level and signals computer 118 and/or external camera 114 and to capture pose information of the patient and imaging system itself via reference markers 108 and 128, respectively. In embodiments, a custom designed optical camera operating in the visible light spectrum, may be utilized as camera 114. In embodiments, such custom designed optical camera may be operably coupled with other elements in system 110, including an embedded AI compute module, a 4k monitoring camera, a medical-grade Wi-Fi chip for high-bandwidth communication, audio, a gyroscope, and security controls to address HIPAA.

Reference markers 108 and 128 are fiducial markers that are easily detectable by the optical camera 114 and are attached to the patient and the calibration target 111, respectively, and serve as points of reference for coordinate transformations. The implementation of reference markers 108 and 128 is set forth in greater detail in US Patent Application Publication US20250186163-A1, and co-pending U.S. patent application Ser. No. 19/204187, entitled “Omni-View Unique Tracking Marker”, Attorney Docket No. 046273.00023, the subject matters of which are incorporated herein by this reference for all purposes.

The radiographic image detector 115A, such as a CT scanner, C-arm CT scanner, or X-ray scanner, or other radiographic image detector, can be connected to the computer 118 via network interface to input image data to the computer 118. Computer 118 executes software that includes reconstruction module 140. Reconstruction module 140 processes the at least one projection input image using camera parameters provided by surgical navigation system 110 to produce a volumetric representation, e.g. 3D reconstruction 150. In embodiments, computer 118 is also operatively coupled to a reconstruction module 140 which generates a 3D reconstruction 150. In embodiments, reconstruction module 140 may also execute a process within or under the control of computer 118.

FIGS. 1B and 1C show an untracked X-ray imaging system suitable for use with the disclosed system and method when connected with a computing device. The X-ray imaging system comprises an X-ray imaging device, such as a standard office X-ray device, acquiring at least one projection input image of a patient anatomy. Multiple projection images are acquired at predetermined approximate orientations, by repositioning the patient at appropriate orientations before each image acquisition. In a first image acquisition 160, patient 162 is positioned facing X-ray source 164, and X-rays are collected by detector 166. In an additional image acquisition 170, patient 172 is positioned at approximately 90 degrees rotation relative to X-ray source 174, and X-rays are collected by detector 176. The predetermined illustrative orientations are exemplary only; any predetermined set of orientations may be used. Acquisition of predetermined orientations by way of repositioning the patient is exemplary only; in other embodiments the orientations may also be acquired by repositioning the X-ray imaging device.

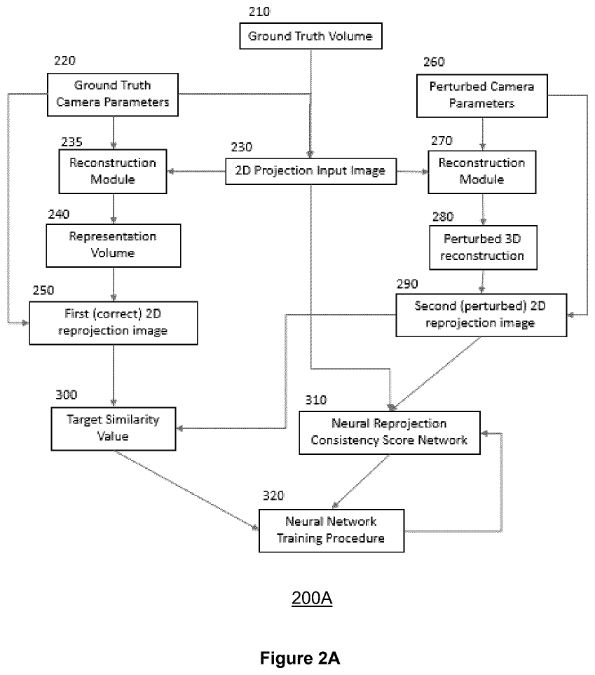

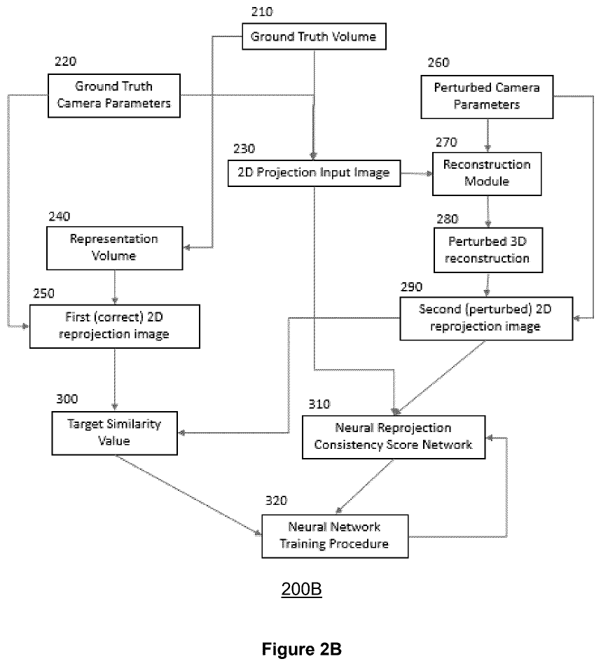

FIGS. 2A and 2B illustrate two exemplary method process flows 200A and 200B, respectively, for implementing a reconstruction-aware learned similarity metric training pipeline, including generation of a representation volume from a ground-truth volume and comparison between a first (correct) image and a second (perturbed) 2D reprojection image. The methods are identical except where noted.

A ground-truth volume 210, e.g. a CT scan, is obtained, along with ground-truth camera parameters 220 and at least one 2D projection input image 230 consistent with such ground-truth volume and ground-truth camera parameters. In some embodiments, the ground-truth camera parameters 220 are generated from a distribution of expected input camera parameters, and the 2D projection input image 230 is a full-field-of-view (full-FOV) DRR generated from the ground-truth volume using such ground-truth camera parameters. In other embodiments, the 2D projection input image 230 is an X-ray image of the same 3D object as is given in the ground-truth volume, and the ground-truth camera parameters 220 are provided by the imaging device, or recovered by way of standard 2D-to-3D registration between the 2D projection input image 230 and the ground-truth volume 210. In some embodiments, the 2D projection input image 230 includes additionally a 2D segmentation mask.

The ground-truth volume 210 is mapped into a chosen representation, yielding a representation volume 240. In embodiments, the representation volume 240 may comprise specific image information such as a segmentation mask, a reconstructable subregion, a reconstructable subset of anatomy, and/or gradients thereof. In FIG. 2A, the representation volume 240 is generated by applying reconstruction module 235 to the 2D projection input image 230 using ground-truth camera parameters 220. In FIG. 2B, the representation volume 240 is generated directly from the ground-truth volume 210, for example, by generating a segmentation mask, a reconstructable subregion, a reconstructable subset of anatomy, and/or gradients thereof directly from a CT scan.

The representation volume 240 is reprojected back into the 2D camera coordinate space using ground-truth camera parameters 220, yielding a first (correct) 2D reprojection image 250. In embodiments, the first (correct) 2D reprojection image 250 comprises a DRR of the representation volume 240. Note that the first (correct) 2D reprojection image 250 contains only information that is present in the representation volume 240.

The first (correct) 2D reprojection image 250 is compared to a second (perturbed) 2D reprojection image 290, which is generated by performing 2D-to-3D reconstruction of the 2D projection input image 230 using a reconstruction module 270 under perturbed camera parameters 260, yielding a perturbed 3D reconstruction 280, and reprojecting such perturbed 3D reconstruction 280 using perturbed camera parameters 260.

A target similarity value 300 is computed between the first and second 2D reprojection images, e.g. by any of gradient normalized cross correlation, Dice coefficient, or other appropriate similarity metric. The target similarity value 300 serves as a training signal to a neural reprojection consistency score network 310. In some embodiments, the neural reprojection consistency score network 310 comprises a regressor, e.g. ConvNext2, a convolutional neural network model for image classification. The 2D projection input image 230 and the second (perturbed) 2D reprojection image 290 are used as inputs to the neural reprojection consistency score network 310. This neural reprojection consistency score network 310 is trained using a standard neural network training procedure 320, using the target similarity value 300 as the supervision target value. The training is performed using a dataset containing at least one ground truth volumes 210 and perturbed camera parameters 260, typically a plurality representing the expected distributions of volumes the reconstruction module will be reconstructing and of expected errors in its input camera parameters. In some embodiments, the training is performed by minimizing the mean-square error between the outputs of the neural reprojection consistency score network 310 and the target similarity value 300, with respect to the trainable weights of the reprojection consistency score network 310. Thus, the reprojection consistency score network 310 is trained to predict the target similarity value 300, based only on inputs comprises the 2D projection input image 230 and the second (perturbed) representation 2D reprojection image 290.

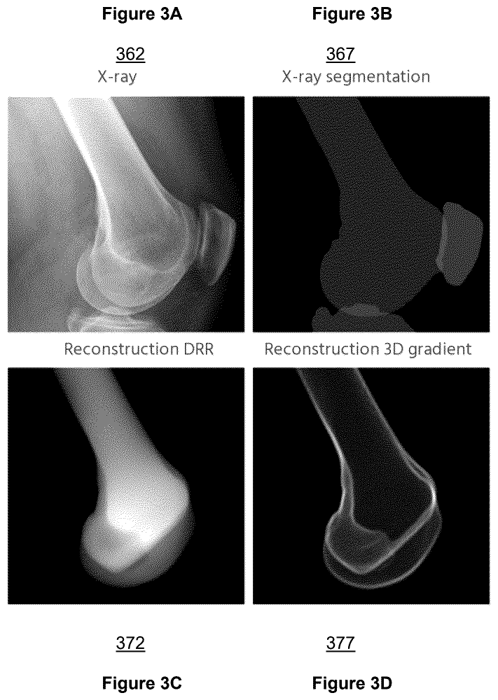

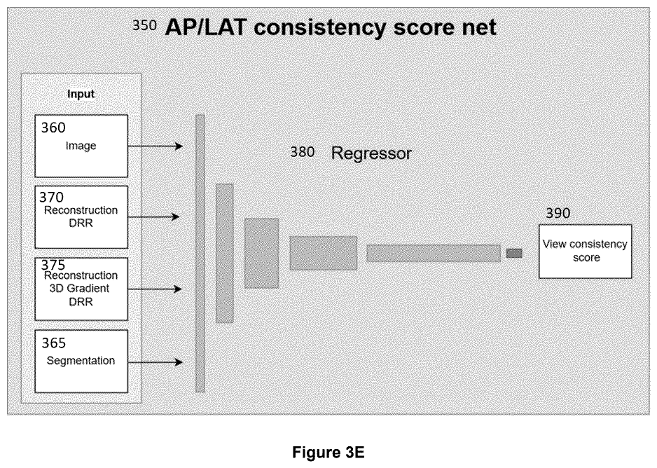

FIGS. 3A-E depicts an exemplary segmentation-mask-based embodiment of a neural reprojection consistency score network 310 that receives an X-ray image and optional 2D segmentation mask together with DRRs of a reconstructed 3D segmentation mask and its gradients, and outputs a view consistency score trained to approximate a target similarity value. In embodiments, multiple instances 350 of the network may be trained, e.g. one for AP images and another for Lateral images. In this embodiment, the 2D projection input image 230 comprises an X-ray image 360, e.g. image 362 in FIG. 3A, as well as an optional 2D segmentation mask 365, e.g. image 367 in FIG. 3B. In this embodiment, the perturbed 3D reconstruction 280 comprises a 3D segmentation mask of the femur, as well as its 3D gradients. The second (perturbed) representation 2D reprojection image 290 comprises a reconstruction DRR 370, e, g, image 372 in FIG. 3C, as well as a reconstruction 3D gradient DRR 375, e.g. image 377 in FIG. 3D.

FIG. 3E illustrates conceptually an exemplary learned similarity metric (view consistency score) in the form of a regressor network in accordance with the disclosure. The reprojection consistency neural network comprises a regressor function 380, e.g. ConvNext2. The network is trained to output a view consistency score 390 that approximates a target similarity value 300. In embodiments, the target similarity value 300 is computed by calculating the normalized cross correlation between the reconstruction 3D gradient DRR 375 which was calculated using perturbed camera parameters 260, and a first, correct representation 2D reprojection image 250 comprises a representation volume 3D gradient DRR calculated using ground truth camera parameters 220. This training procedure teaches the neural reprojection consistency score network 350 to extract only information relevant to the reconstruction 3D gradient DRR 375 from its input projection images 360 and 365, while ignoring irrelevant image information such as gradients stemming from the patella, the tibia, the soft tissue, and bony textures, such as local bone density variations that are seen in the X-ray but do not stem from the thickness of the bone in the reprojection direction and are therefore missing from the reconstructor's representation domain.

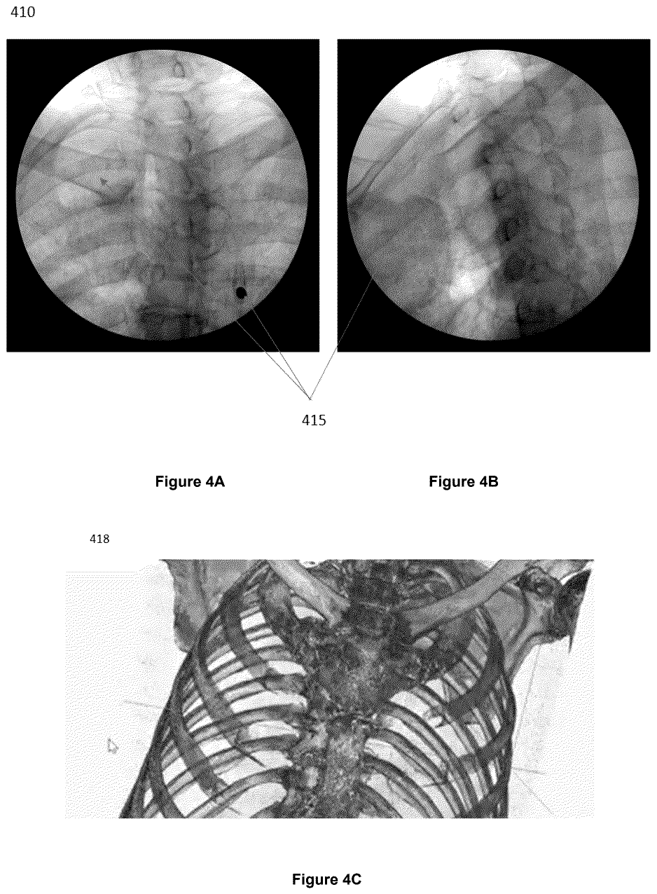

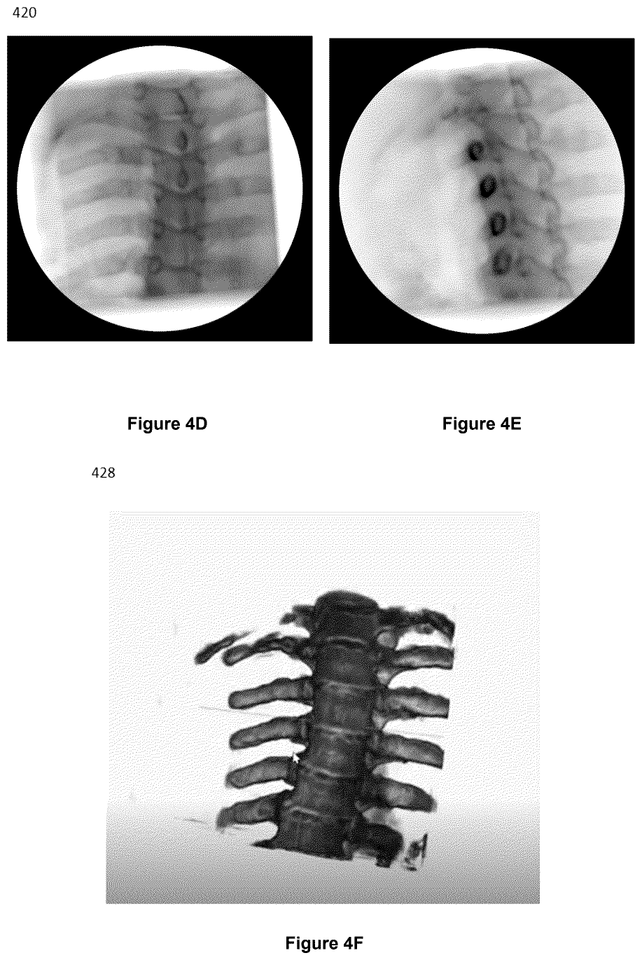

FIGS. 4A-F highlight limited-field-of-view effects in which a reconstructed 3D volume represents only partial anatomy, motivating similarity metrics that restrict computation to representable regions. The reconstructed 3D volume's FOV may comprise only partial anatomy. Therefore, not all features 415 present in the original X-ray images 410 (which are AP and 45-degree projections of full-FOV patient anatomy 418) will be present in DRR's 420 (embodying representation 2D reprojection images 290) that are generated by AP and 45-degree reprojection of the limited-FOV reconstructed 3D volume 428. Similarity metrics account for this mismatch by learning to restrict similarity computation to representable regions.

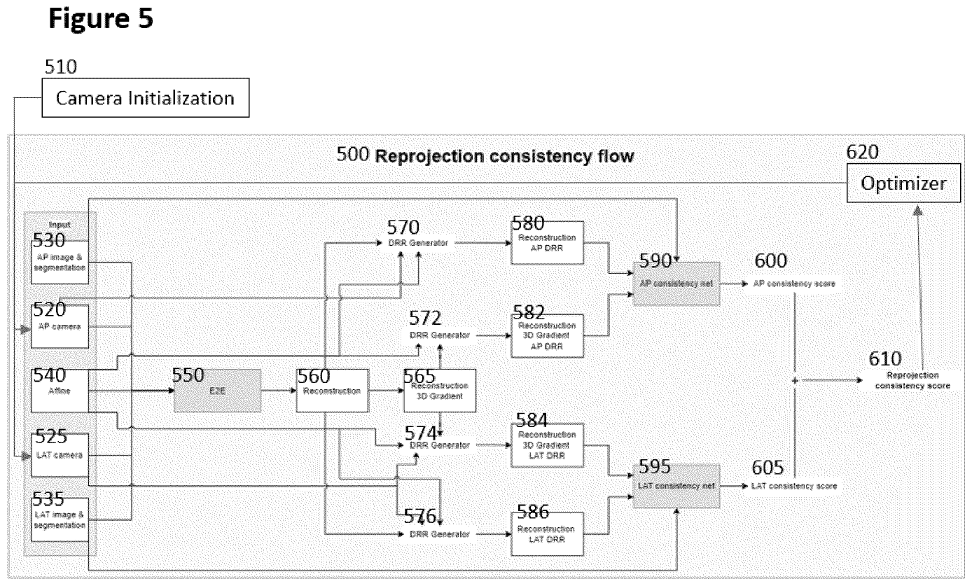

FIG. 5 is a flowchart of an inference-time iterative self-calibration procedure in accordance with the disclosure. In embodiments, the inference-time iterative self-calibration procedure 500 estimates camera parameters for AP and Lateral X-ray images by repeatedly reconstructing a 3D volume, generating DRRs and gradient DRRs, computing reprojection consistency scores for AP and Lateral views, and updating the camera parameters to maximize the combined reprojection consistency score. The iterative procedure 500 is used to estimate precise camera parameters 520, 525 of AP and Lateral X-ray images, given said images together with their 2D segmentation masks 530, 535. Initial approximate camera parameters are estimated by an initialization process 510.

In some embodiments, the initialization process 510 includes obtaining approximate camera poses from a tracked imaging system such a tracked C-arm system. In other embodiments, the camera initialization process 510 includes using nominal approximate camera poses of a predetermined configuration such as AP and Lateral X-rays (which are assumed to be approximately orthogonal). In further embodiments, the initialization process 510 includes detecting corresponding landmarks in at least a pair of projection input images and calculating the initial values of the approximate camera parameters using a geometry-based relative pose estimation algorithm.

An affine transformation 540 defines the reconstruction volume bounds. An end-to-end differentiable reconstruction module 550 is used to generate a proposed 3D reconstruction 560 and its 3D gradient 565, given the current input images 530, 535 and their corresponding current estimated camera parameters 520 and 525. In embodiments, DRR generators 570, 572, 574, 576 are used to generate AP and Lateral DRR's 580, 582, 584, 586, respectively, of the reconstruction 560 and its gradient 565, using current estimated camera parameters 520, 525.

A first neural reprojection consistency network 310 that was previously trained on AP projections (yielding AP consistency net 590) computes an AP consistency score 600, using the AP image & segmentation 530 as its 2D projection image 230 input (see processes 200A and 200B), and using the reconstruction AP DRR 580 and the reconstruction 3D gradient AP DRR 582 as its second (perturbed) 2D reprojection image 290 input (see processes 200A and 200B).

A second neural reprojection consistency network 310 that was previously trained on Lateral (LAT) projections (yielding LAT consistency net 595) computes a LAT consistency score 605, using the LAT image & segmentation 535 as its 2D projection image 230 input, and using the reconstruction Lateral DRR 584 and the reconstruction 3D gradient Lateral DRR 586 as its second (perturbed) 2D reprojection image 290 input.

A final reprojection consistency score 610 is computed by summing the AP and the Lateral consistency scores 600, 605. An optimizer 620, such as Covariance Matrix Adaptation Evolution Strategy (CMA-ES) or gradient descent, is used to maximize the reprojection consistency score 610 by modifying camera parameters 520, 525 in an iterative process. The iterative loop process 500 converges to refined camera parameters 520, 525 compatible with the X-ray inputs 530, 535, such that reconstruction reprojections 580, 582, 584, 586 are as consistent as possible with inputs 530, 535 given the refined camera parameters 520, 525.

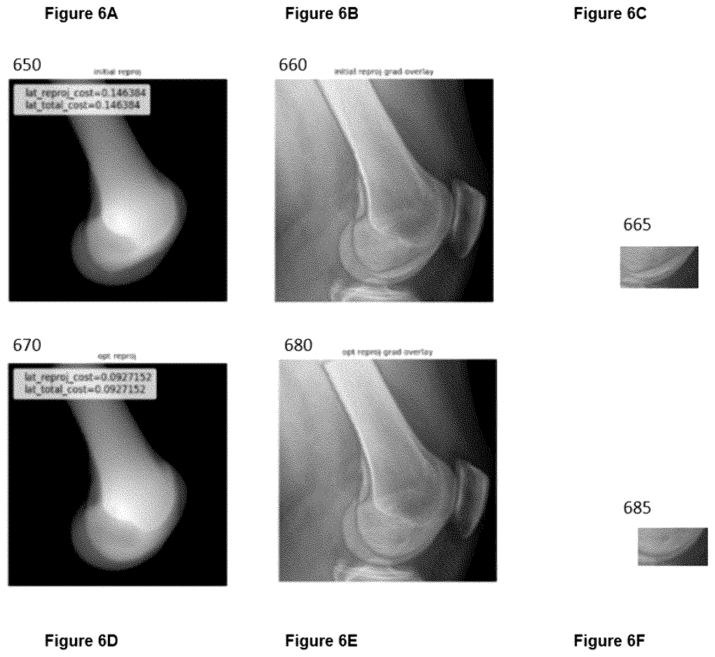

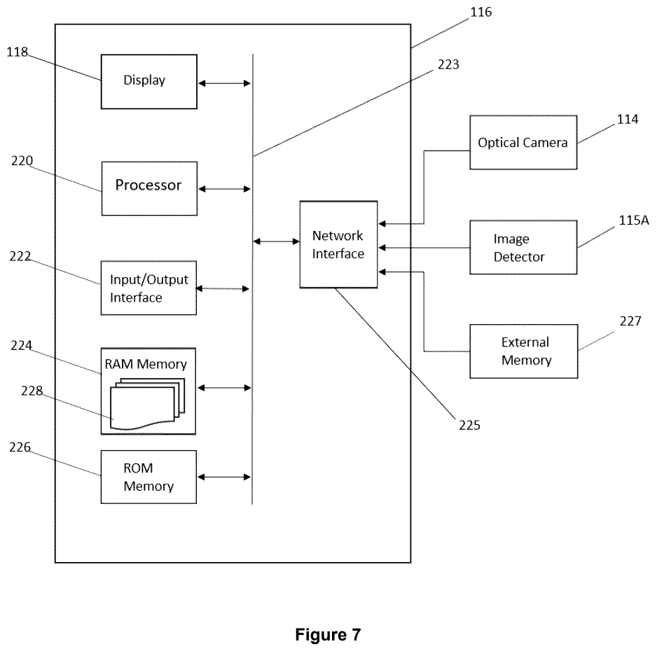

FIGS. 6A, 6B, 6C, 6D, 6E, and 6F provide visual examples of the effects of the iterative self-calibration procedure, showing initial and final Lateral (LAT) DRRs overlaid on a LAT X-ray image and zoomed-in views demonstrating improved alignment of the reconstruction 3D gradient DRR with the underlying condyle contour after refinement of the LAT camera pose. Image 650 of FIG. 6A shows the initial reconstruction LAT DRR 586, generated using initial estimated LAT camera 525, with initial reconstruction 3D gradient LAT DRR 584 shown overlaid in blue. Image 660 of FIG. 6B shows the LAT X-ray image 535, with initial reconstruction 3D gradient LAT DRR 584 shown overlaid in blue. Detail image 665 of FIG. 6C shows an area in which the initial reconstruction 3D gradient LAT DRR 584 is mismatched with the underlying LAT X-ray image 535 at the contour of one of the condyles.

Image 670 of FIG. 6D shows the final reconstruction LAT DRR 586, generated using final estimated LAT camera parameters 525 after said parameters were optimized using the self-calibration procedure 510, with the final reconstruction 3D gradient LAT DRR 584 shown overlaid in blue. Image 680 of FIG. 6E shows the LAT X-ray image 535, with final, optimized reconstruction 3D gradient LAT DRR 584 shown overlaid in blue. Detail image 685 of FIG. 6F shows an area in which the final reconstruction 3D gradient LAT DRR 584 is now correctly matched with the underlying LAT X-ray image 535 (at the contour of one of the condyles), thanks to improved estimation of the LAT camera pose.

The methods described herein may be implemented on a computer 118 using well-known computer processors, memory units, storage devices, computer software, and other components. FIG. 7 is a conceptual illustration of a high-level block diagram of such a computer suitable for use with the disclosed system and methods.

In embodiments, computer 118 comprises display 116, processor 220, I/O interface 222, memories 224 and 226, and network interface 225, all operatively interconnected by bus 223. Network interface 225 operatively connects cameras 114, radiographic image detector 115A, and external memory 227 to the other components of computer 118, as illustrated in FIG. 26. Processor 221 controls the overall operation of the computer 118 by executing software modules or applications comprising computer program instructions 288 which define such operation functionality. The computer program instructions 228 may be stored directly in memory 224 or in an external storage device 227 (e.g., magnetic disk) and loaded into memory 224 when execution of the computer program instructions is desired. Thus, the processes described herein may be defined by the computer program instructions stored in the memory 224 and/or storage 227 and controlled by the processor 221 executing the computer program instructions. ROM memory 226 typically contains computer program instructions comprising the operating system and basic input/output system firmware to provide runtime services for the operating and programs and to perform hardware initialization during power on startup processes.

A radiographic image detector 115A, such as a CT scanner, C-arm CT scanner, or X-ray scanner, or other radiographic image detector, can be connected to the computer 118 via network interface 225 to input image data to the computer 118. It is possible to implement the radiographic image detector 115A and the computer 118 as one device. It is also possible that radiographic image detector 115A and the computer 118 communicate wirelessly through a network infrastructure. In embodiments, the computer 118 can be located remotely with respect to the radiographic image detector 115A and the process described herein can be performed as part of a server or cloud based service. In this case, the process may be performed on a single computer or distributed between multiple networked computers. The computer 118 also includes one or more network interfaces 125 for communicating with other devices via a network. The computer 118 also includes other input/output devices 222 that enable user interaction with the computer 118 (e.g., display, keyboard, mouse, speakers, joystick controllers, etc.). One skilled in the art will recognize that an implementation of an actual computer could contain other components as well, and that FIG. 7 is a high level representation of some of the components of such a computer for illustrative purposes.

Although the systems and methods disclosed herein have been described with reference to patient anatomy and surgical planning and/or navigation procedures, their applicability is not limited to the same. Any of the systems and methods disclosed herein may be utilized in other situations, including industrial control, package or baggage handling, or any other environments in which 3D volume reconstruction is required.

As used herein the term “radiographic” or “radiography” or variations thereof are intended to include both traditional X-ray technology and images and as well as fluoroscopy or fluoroscopic technology and images. As used herein, the acronym “DOF” means degree(s) of freedom. As used herein, the acronym “2D” means two dimensional. As used herein, the acronym “3D” means three dimensional. As used herein, the acronym “FOV” means Field-of-View.

Although many embodiments are described in the context of X-ray imaging, the disclosed techniques are applicable to any projection-based imaging modality that generates two-dimensional projections of a three-dimensional object.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

At various places in the present specification, values are disclosed in groups or in ranges. It is specifically intended that the description includes each and every individual sub-combination of the members of such groups and ranges and any combination of the various endpoints of such groups or ranges. For example, an integer in the range of 0 to 40 is specifically intended to individually disclose 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, and 40, and an integer in the range of 1 to 20 is specifically intended to individually disclose 1, 2, 3, 4, 5, 6, 7, 8, 9, 10, 11, 12, 13, 14, 15, 16, 17, 18, 19, and 20.

To the extent that the term “includes” or “including” is employed in the detailed description or the claims, it is intended to be inclusive in a manner similar to the term “comprising” as that term is interpreted when employed as a transitional word in a claim.

Throughout this specification and the claims that follow, unless the context requires otherwise, the words ‘comprise’ and ‘include’ and variations such as ‘comprising’ and ‘including’ will be understood to be terms of inclusion and not exclusion. For example, when such terms are used to refer to a stated integer or group of integers, such terms do not imply the exclusion of any other integer or group of integers.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

For purposes of clarity and a concise description, features are described herein as part of the same or separate embodiments, however, it will be appreciated that scope of the concepts may include embodiments having combinations of all or some of the features described herein. Further, terms such as “first,” “second,” “top,” “bottom,” “front,” “rear,” “side,” and other are used for reference purposes only and are not meany to be limiting.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to an example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

While example systems, methods, and other embodiments have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and other embodiments described herein. Therefore, the invention is not limited to the specific details, the representative apparatus, and illustrative examples shown and described. Thus, this application is intended to embrace alterations, modifications, and variations that fall within the scope of the appended claims.

1. A computer-implemented method of training a reconstruction-aware learned similarity metric for self-calibrating relative camera parameters used in multi-view projection-based two-dimensional-to-three-dimensional reconstruction, the method comprising:
(a) obtaining a ground-truth three-dimensional representation of an object and ground-truth camera parameters for at least one two-dimensional projection input image of the object;
(b) defining a representation function that maps a three-dimensional representation into a representation domain used by a two-dimensional-to-three-dimensional reconstruction module;
(c) projecting the ground-truth three-dimensional representation under the ground-truth camera parameters to obtain a first two-dimensional reprojection image;
(d) reconstructing, using a reconstruction module and the at least one two-dimensional projection input image, a perturbed three-dimensional reconstruction based on estimated camera parameters that differ from the ground-truth camera parameters, and projecting the perturbed three-dimensional reconstructed representation under the estimated camera parameters to obtain a second two-dimensional reprojection image;
(e) determining, by applying a similarity function configured to quantify agreement between the first and second two-dimensional reprojection images, a target similarity value; and
(f) training the reconstruction-aware learned similarity metric using training input data comprising the at least one two-dimensional projection input image and a corresponding second two-dimensional reprojection image, so that the reconstruction-aware learned similarity metric is configured to output a similarity score that approximates the target similarity value.

2. The method of claim 1, wherein the representation function expresses the three-dimensional representation as a three-dimensional segmentation or occupancy representation of at least one anatomical structure.

3. The method of claim 2, wherein (c) comprises any of:
c1) generating a DRR of a three-dimensional segmentation or occupancy representation of at least one anatomical structure, and
c2) generating a DRR of three-dimensional gradients of a three-dimensional segmentation or occupancy representation of at least one anatomical structure.

4. The method of claim 2, wherein the ground-truth three-dimensional representation comprises at least one of:
(i) a three-dimensional segmentation mask derived from a ground-truth volumetric image; and
(ii) a three-dimensional reconstruction generated using the reconstruction module under the ground-truth camera parameters.

5. The method of claim 1, wherein the representation function expresses the three-dimensional representation as any of: an attenuation or density representation, a gradient-domain representation, a distance-based representation, an implicit field, a radiance representation, and a latent feature representation used by the reconstruction module, and combinations thereof.

6. The method of claim 1, wherein (e) comprises:
(e1) evaluating a similarity function selected from a class of functions configured to measure agreement between corresponding pixels or regions of the first and second two-dimensional representation images.

7. The method of claim 6, wherein the selected similarity function is configured to measure agreement on any of intensity-based, gradient-based, mask-based, silhouette-based, distance-transform-based, and feature-space-based similarity functions, and combinations thereof.

8. The method of claim 1, further comprising, prior to (c), restricting the ground-truth three-dimensional representation according to at least one reconstruction-conditioned criterion so that the first two-dimensional reprojection image corresponds substantially to a region that is representable by the reconstruction module given the at least one projection input images.

9. The method of claim 8, wherein restricting comprises determining a reconstruction-conditioned sub-volume based on at least one of:
(i) a bounding region derived from a three-dimensional reconstruction generated under the ground-truth camera parameters;
(ii) a ray-coverage or overlap criterion; and
(iii) an overlap map predicted by a neural network.

10. The method of claim 1, wherein determining the target similarity value comprises aggregating similarity values across multiple views.

11. (canceled)

12. A system comprising one or more processors and memory storing instructions which, when executed by the one or more processors, cause the system to perform a method of training a reconstruction-aware learned similarity metric for self-calibrating relative camera parameters used in multi-view projection-based two-dimensional-to-three-dimensional reconstruction, the method comprising:
(a) obtaining a ground-truth three-dimensional representation of an object and ground-truth camera parameters for at least one two-dimensional projection input image of the object;
(b) defining a representation function that maps a three-dimensional representation into a representation domain used by a two-dimensional-to-three-dimensional reconstruction module;
(c) projecting the ground-truth three-dimensional representation under the ground-truth camera parameters to obtain a first two-dimensional reprojection image;
(d) reconstructing, using the reconstruction module and the at least one two-dimensional projection input image, a perturbed three-dimensional reconstruction based on estimated camera parameters that differ from the ground-truth camera parameters, and projecting the reconstructed representation under the estimated camera parameters to obtain a second two-dimensional reprojection image;
(e) determining, by applying a similarity function configured to quantify agreement between the first and second two-dimensional reprojection images, a target similarity value; and
(f) training the reconstruction-aware learned similarity metric using training input data comprising at least one two-dimensional projection input image and corresponding second two-dimensional reprojection image, so that the reconstruction-aware learned similarity metric is configured to output a similarity score that approximates the target similarity value.

13. A computer-implemented method for self-calibrating relative camera parameters of imaging devices configured to acquire two-dimensional projection images of a three-dimensional object, the method comprising the following acts:
(a) receiving at least one projection input image of the object;
(b) receiving or estimating initial approximate camera parameters associated with the at least one projection input image;
(c) generating, using a two-dimensional-to-three-dimensional reconstruction module, a three-dimensional reconstruction of the object based on the at least one projection input image and the initial approximate camera parameters, the three-dimensional reconstruction belonging to a representation domain used by the reconstruction module;
(d) projecting the three-dimensional reconstruction using the approximate camera parameters to obtain, for each view, a two-dimensional reprojection image;
(e) for each view, computing a reprojection consistency score using a reconstruction-aware learned similarity metric, the reconstruction-aware learned similarity metric receiving the corresponding projection input image and the corresponding two-dimensional reprojection image;
(f) updating at least one camera parameter based at least in part on the reprojection consistency score; and
(g) repeating acts (c)-(f) until a convergence condition is satisfied, thereby producing refined camera parameters and an improved three-dimensional reconstruction.

14. The method of claim 13, wherein the at least one projection input image comprises at least a pair of projection input images acquired nominally in a predetermined configuration and act (b) comprises using such predetermined configuration.

15. The method of claim 13, wherein the imaging device comprises a tracked C-arm system, and act (b) comprises receiving initial approximate camera parameters from such tracked C-arm system.

16. The method of claim 13, wherein the at least one projection input image includes at least a pair of projection input images, and act (b) comprises detecting corresponding landmarks in the at least a pair of projection input images and calculating the initial approximate camera parameters using a geometry-based relative pose estimation algorithm.

17. The method of claim 13, wherein the representation domain comprises a three-dimensional segmentation or occupancy representation, and the reprojection consistency score reflects agreement between projected segmentation or occupancy representation and anatomical structures visible in the projection input images.

18. The method of claim 13, wherein act (f) comprises determining gradients of the reprojection consistency score with respect to at least one of the camera parameters by backpropagating through at least a projection operation, and applying a gradient-based optimization algorithm.

19. The method of claim 13, wherein act (f) comprises using a global optimizer such as a Covariance Matrix Adaptation Evolution Strategy (CMAES).

20. The method of claim 13, wherein act (f) comprises refining at least one rotational degree of freedom and/or at least one translational degree of freedom around the initial approximate camera parameters, and further including imposing a prior favoring refined camera parameters that are similar to initial approximate camera parameters and/or consistent with a predetermined nominal constraint such as orthogonality.

21. The method of claim 13, wherein the reprojection consistency score is aggregated across a plurality of views.

22. (canceled)

23. A system comprising one or more processors and memory storing instructions which, when executed by the one or more processors, cause the system to perform a method for self-calibrating relative camera parameters of imaging devices configured to acquire two-dimensional projection images of a three-dimensional object, the method comprising:
(a) receiving at least one projection input image of the object;
(b) receiving or estimating initial approximate camera parameters associated with the at least one projection input image;
(c) generating, using a two-dimensional-to-three-dimensional reconstruction module, a three-dimensional reconstruction of the object based on the at least one projection input image and the approximate camera parameters, the reconstruction belonging to a representation domain used by the reconstruction module;
(d) projecting the three-dimensional reconstruction using the approximate camera parameters to obtain, for each view, a two-dimensional reprojection image;
(e) for each view, computing a reprojection consistency score using a reconstruction-aware learned similarity metric, the reconstruction-aware learned similarity metric receiving the corresponding projection input image and the corresponding two-dimensional reprojection image;
(f) updating at least one camera parameter based at least in part on the reprojection consistency score; and
(g) repeating (c)-(f) until a convergence condition is satisfied, thereby producing refined camera parameters and an improved three-dimensional reconstruction.
